(19) United States
(12) Patent Application Publication
(10) Pub. No.: US 2002/0116340 A1
(43) Pub. Date: Aug. 22, 2002

(54) Method and system for retrieving data from the XSLM license manager

(75) Inventors: Per Hellberg, New York, NY (US); Robert Barritz, New York, NY (US)

Correspondence Address: OSTROLENK FABER GERB & SOFFEN, 1180 AVENUE OF THE AMERICAS, NEW YORK, NY, 100368403

(73) Assignee: Isogon Corp.

(21) Appl. No.: 10/037,524

(22) Filed: Oct. 24, 2001

Related U.S. Application Data
(60) Provisional application No. 60/243,211, filed on Oct. 25, 2000.

(51) Int. Cl. G06F 17/60; G06F 7/00

(52) U.S. Cl. 705/59; 707/9

(57) ABSTRACT

The invention is a data retrieving system for a computer, including a plurality of application programs that operate with license manager handles issuance of license certificates to the plurality of applications programs and the data logger of the license manager creates log records containing data reflecting usage of application programs. The log records include parametric fields by which license certificate transactions are classified. A search formulating facility responds to user inputs by formulating parametric criteria in the form of log data searching specifications which are then used by a data collection facility to search through the log records to retrieve records that comply with the searching specification created by the data retrieving facility.

### RELATED APPLICATION

This Application claims priority and is entitled to the filing date of U.S. Provisional Application Serial No. 60/243,211 filed Oct. 25, 2000, and entitled “METHOD AND SYSTEM FOR RETRIEVING DATA FROM THE XSLM LICENSE MANAGER”, the contents of which are incorporated by reference herein.

### BACKGROUND OF THE INVENTION

The present invention relates generally to software licensing and, more particularly, to a system and method which improves the capabilities and speed of operation of general purpose software license compliance/verification license managers.

Much of the software in use by corporations, organizations and individuals is licensed either directly or indirectly from a variety of software vendors. The rights granted the licensees can take a variety of forms. For example, a software product might be licensed to an organization for unlimited use, on any number of computers (which term should be understood herein to encompass complexes of computers, networks of computers, or partitions of computers), but only within that organization. Or, the organization might be permitted to only use the software on certain computers, or to only allow use by certain named employees, or by only a specified maximum number of concurrent employees, or until a specified date, or only on certain days of the week, or based on any other set of rights and restrictions that the vendor may negotiate with the organization.

In many cases, vendors have incorporated protective mechanisms (PMs) into their software products to try and determine whether the usage restrictions that are embodied in the license terms are ever violated in practice. For example, such a PM, which is typically invoked each time the associated software product is initiated, might determine whether the computer (as identified by such things as a serial number or other unique characteristic) that the software is operating on is on the list of computers that the software is licensed to. Or, the PM might count the number of users concurrently using the software, checking to see whether a licensed maximum is ever exceeded.

If the PM detects attempted violations, a variety of actions may be taken, from issuing a warning while allowing execution, to preventing the software from operating.

For the PM to be able to match the actual use of a software product to the organization's licensed rights, the PM must know what those rights are. These are often supplied via an encrypted password or certificate which the software vendor gives to the organization, which in turn supplies it to the PM. Typically, a PM will not allow the software product to operate at all if a certificate is not supplied or is missing, expired, or otherwise not made “known” to the PM.

While many vendors have developed their own PMs to enforce license restrictions, some use general purpose software supplied to them by other vendors. Such facilities, known as License Managers (LMs), are available from a variety of vendors, including Isogon (LicensePower/iFOR), Globetrotter (FLEXlm), IBM (LUM), and Rainbow (SentinelLM).

Typically, when a licensed software product begins its execution, it invokes the LM, perhaps using an Application Programming Interface (API) defined for this purpose by the vendor of the LM, and supplying identification information consisting of the identity of the software product, and possibly also version and/or feature information, providing for a more granular definition of what is being licensed. The LM determines if there exists a license certificate corresponding to the software product in question, and, if so, whether the licensed rights detailed in the certificate match the circumstances of use. If they do, a “clear-to-proceed” response is returned to the licensed software product. But if they do not—if, for example, the licensed software product is currently executing on a computer whose serial number is not defined in the certificate—the LM returns an “out-of-compliance” response to the licensed software product, which can take whatever action the vendor of the software product has deemed appropriate under that circumstance.

Similarly, the LM vendor may provide a management program or API that is used by applications that implement such functions as installing, updating, and deleting license certificates, and extracting usage data for reporting.

Although there may be many physical servers in a computer system, a licensed product may communicate with just a single, logical license server that is embodied in the API of the LM. The library of software composing the API on the local computer directs requests to a library on the physical server that then processes the request, oftentimes enforcing license rights for a product that may encompass multiple computers.

While LMs from different vendors share the general functionality described above, they differ from one another in a variety of ways, for example with regard to the particular set of functions supported by their API, or in the way in which the end-users supply certificates to the License Server or otherwise administer and operate the licensing system. If an end-user licenses two or more software products whose vendors have employed different LMs, the end-user will have to operate and administer multiple LM systems. For example, if an end-user licenses both ProductX, which requires the services of FLEXlm, and ProductY, which requires LUM, the end-user will have to install, operate and administer both FLEXlm and LUM. And if other products licensed by the end-user require LicensePower/iFOR (a product of the assignee of the present invention) and SentinelLM, these would have to be installed, operated and administered as well.

In March of 1999, an IT (Information Technology) industry standard for LMs was approved by The Open Group. The standard, known as XSLM, addresses the interoperability problems among different license management systems, license certificate formats, and operating environments. XSLM also provides a mechanism for the creation of useroriented tools to aid in the management of software licenses and application use monitoring. The specification addresses four areas:

A common license certificate format that makes it possible to define the licensing terms and conditions in an environment-independent way.

An application API that is used by applications which require the licensing capabilities provided by an XSLM-compliant system.

A recording and logging definition that specifies the minimum data that must be recorded by an XSLM-compliant system.

A management API that is used by XSLM applications which implement such functions as installing, updating, and deleting license certificates, and extracting usage data for reporting.

A Common License Certificate Format: A central part of the XSLM specification is the concept of a license certificate specified in a common license certificate format. A license certificate is the encoding, into a standard format, of the terms and conditions that are contained within a license agreement governing the use of a particular product. This holds true, no matter how the product is licensed-whether via a direct negotiation between software publisher and customer (in which case there often exists a license agreement specific to a particular transaction), or as a “shrink-wrap” license.

The common license certificate format is such that an external license certificate can be created on a platform different from that where the external license certificate will be installed (i.e., the location of the license server), and different from the platform where the licensed application actually will be running. There is no requirement that the tools used to create a license certificate and to install it into a license server are provided by the same licensing system software publisher. The only requirement is that the tools used by both licensing system software publishers and customers can create and accept the same external representation, that is the common license certificate format.

A license certificate will contain sufficient security and integrity data (such as digital signatures) to ensure that tampering can be detected by the XSLM system, or directly by the application when it requests a license.

The Application API: The Application API (XAAPI) defines the interface that any licensing system-enabled application uses to interact with an XSLM-compliant license server, to include license verification and to handle all the activities associated with it. The intent is to standardize the way in which common functionality provided by existing licensing systems can be accessed. These API functions allow software publishers to enable applications in a way that is independent of the underlying (XSLM-compliant) licensing system.

Although there may be many physical servers, the application product communicates with just a single, logical license server that is embodied in the API library. Application products direct requests to a library that provides the XAAPI interface, not directly to a physical server.

The primary function of the XAAPI is to:

Provide a standard API, to be adopted by a variety of software publishers, that any application product may use on different operating systems and network environments;

Be easy to use;

Provide support for all commonly used licensing policies;

Provide support for different levels of application complexity and accommodate different levels of protection against licensing system tampering.

The XAAPI functions fall into two sets: a basic API and an advanced API. The basic set includes the minimum function required to provide support for a basic, yet complete, licensing activity. The advanced set includes and extends the functionality of the basic set. It provides the application developer with more flexibility and options in support of a more complex licensing scheme.

The Recording and Logging Services: A crucial function of an XSLM licensing system is to collect and record data about the usage of the licensed products and about relevant events related to license management. A compliant XSLM system will maintain three types of information: certificate data, status data, and historic (or logged) data.

The certificate data is the combination of information provided by the application software publisher (embodied in the license certificate), which cannot be modified by the licensing system or by the administrator; information provided by the customer's license administrator (to complement or override, when allowed, the licensing policy specified in the license certificate); and information created and maintained by the licensing system itself.

The status data is maintained by the licensing system while it is running, and at each point in time it provides information about the licenses presently in use, and the value of the meters (also called counters) maintained by the licensing system. Some applications can be licensed based on the count of some units whose meaning in general is known only to the application, and the licensing system keeps track of the units to be counted, acting as a “record keeper;” the updating of the meter is explicitly requested by the application via an API call. A change in the status information is triggered by external (to the licensing system) events, such as the request for a new license, or a change in policy setting (e.g. the administrator switching from soft stop to hard stop) or the expiration of a timer.

The historic data is the persistent log of events relevant to license management. All events related to license administration actions will always be logged, as they can constitute an audit trail (e.g. the addition or deletion of a certificate to/from the license database). The logging of events related to license usage (e.g. an application requesting or releasing a license, or a meter being updated) will usually be under administrator's control.

The Management API: The Management API (XMAPI) is the component that enables license use management systems provided by multiple software publishers to be managed as a single logical licensing system. The XMAPI provides license management applications with an implementation independent means of:

Installing and removing software license certificates

Retrieving information about installed software license certificates, software license usage, and selected licensing system properties

Updating the properties of installed software licenses

The specification does not prescribe the physical structure of the data, or the means by which an implementation chooses to store the data it collects and maintains. It does, however, define the logical structure of the data passed to, and received from a license server, via the XMAPI. The specification also defines the persistency requirements for data transmitted to the licensing system across selected management API functions.

This self-defining data architecture provides for additional implementation specific data to be transmitted across the XMAPI. To permit this flexibility while maintaining compatibility with other compliant licensing systems, XSLM mandates that each implementation ignore any data received across the API that does not carry that implementation's unique publisher identification.

Obtaining log data and license use data: Typically, a great number of discrete events, requests, and decisions will occur within the XSLM system, most of which are captured by the XSLM system as log data, categorized and differentiated by class, record type and record subtype. The current XSLM specification defines three classes (Administration, Application and Licensing System), with a total of 15 record types, containing a total of 56 record subtypes, leading to an extensive variety of unique log records, one for each valid combination of class, type and subtype.

This data may be used by a variety of applications, utilities, or report programs to report on varying types of activity, such as the installation, modification or deletion of certificates for the Administration class; or for log entries of class Application, the activity of licensed products as evidenced by their requests for licenses, license-request activity by computer, or by user, or by time period, etc. The business issues addressed by various applications may include verification of license compliance, optimization of licensed rights, monitoring of user activity, and asset management.

One of the functions included in the XMAPI is the xslm_get_log_data( ) function, which instructs the XSLM to extract and return specified log data. Application programs or utilities needing the information contained in particular log records, or types or subtypes of log records, may employ the xslm_get_log_data( ) function to obtain this information by supplying parametric input information describing the log record data to be obtained, as well as the time period covered by the request. Any log data falling outside this time period, even if otherwise corresponding to the request, will not be returned. The parametric information supplied to the xslm_get_log_data( ) function includes the following:

1. Start-time—The earliest point in time for which log records are to be retrieved.

2. End-time—The last point in time for which log records are to be retrieved.

3. Log_class—The particular class (Administrative data, Application data, or Licensing System data) containing the log record(s) to be retrieved.

4. Log_record_type—Within the specified class, the particular record type to be retrieved.

5. Log_record_subtype—Within the specified class and type, the particular record subtype to be retrieved.

To honor a particular xslm_get_log_data( ) request such as returning the log data for a specific class/type/subtype pertaining to a period of a month, the XSLM system has to search through all the log data generated during that month, matching each log record against the supplied class, type, and subtype. In an active computer system or network of computers, which may comprise hundreds of individual computers, all served by a single XSLM system, hundreds or even thousands of license management requests or events may occur each second, potentially resulting in the production of a vast volume of log data. In some systems, if all eligible data is logged (this can be controlled by the user), the data produced in a month might consist of billions of records, comprising hundreds of billions of bytes of storage.

Disadvantageously, searching through all this data to satisfy a particular xslm_get_log_data( ) request will take a considerable amount of time, as well as attendant system overhead in the form of CPU processing and input/output activity. Amplifying and exacerbating this problem is the fact that many application programs or utilities will require log records of not just a single class, type, or subtype; but of several or many such combinations. And each such desired combination requires a separate xslm_get_log_data( ) request, and each such request will engender the same extensive, start to finish search of the entire month's data.

Moreover, the data returned by the xslm_get_log_data( ) function will pertain to the activity of all products (possibly thousands), from all vendors (possibly hundreds or thousands), on all the computers that the License Server serves (possibly hundreds or thousands), even though the requester may really only require information pertaining to the activity of a small subset of those products and/or vendors and/or computers.

A further problem arises if the application or utility wishes to determine the last occurrence of some particular logged event, such as the last occasion that a particular product was permitted to run (i.e., a license was granted) on either a particular computer, a set of computers, or all computers. In the XSLM system, a license product uses either the xslm_basic_request_license( ) or xslm_adv_request_license( ) API functions to request that a license be granted. However, in this case, though each such license request may be logged, it is not known how far back in time to go to find the last such request, and therefore the application or utility might engage one of several strategies. It could issue a xslm_get_log_data( ) request specifying a start-time that precedes the gathering of any log data, such as of Jan. 1, 1995. Or it could issue xslm_get_log_data( ) requests for increasingly wider time intervals (such as one month, three months, one year, five years) until a logged instance of a xslm_basic_request_license( ) or xslm_adv_request_license( ) request is found. Either strategy requires that the XSLM system potentially search through extensive amounts of log data, perhaps having to search through the same data several times. Moreover, the data returned to the application or utility may be an embarrassment of riches, in that it may contain thousands or millions of instances (especially if the chosen time interval is wide), while the application only cares about the most recent instance, which it will have to find for itself in the returned data.

Yet another problem arises from the fact that, as alluded to above, users of the XSLM system may exercise control as to which log records are actually written to the log. Users will typically run a number of routine processes that will extract and report on log data. To minimize the system overhead created by this activity (and to reduce the data volume of the log data), users, on a certificate by certificate basis, may specify that only certain types of log records be actually written to the log, while discarding others. Or, if filtering of log records is supported by the XSLM, users may elect to filter out certain categories of log records on a class, type, and/or subtype basis. However, as a result of this filtering activity, certain log records that might be useful or instrumental to a particular application or utility may not be recorded on the log by the XSLM system.

### SUMMARY OF THE INVENTION

It is an object of the present invention to generally overcome the aforementioned drawbacks of the prior art.

In general, the invention introduces additional instrumentalities in existing software as well as additional software that allows users to better set parameters in a manner which reduces the overhead of the computer in searching for information concerning the use of licensed software in a manner which saves information that a centralized license manager might not otherwise maintain.

One instrumentality of the invention comprises an improved search engine that incorporates a specification builder and operates through a function known and described below as GETLOGX, by which an operator can specify a general criteria for searching so that when a search is initiated and the log data is examined, multiple log entries and a large variety of data field types are gathered and collected in an output buffer based on the specification criteria, thus avoiding searching through the entire database multiple times. To this end, the invention employs tree-list searching and/or binary truth tables to improve the search engine capability.

Recognizing that the central license manager does not otherwise store qualitative information such as the last instance of license certificate usage, the invention also provides data buffering and collection independent of the central license manager, to store information regarding the last instance of usage of license certificates usage and other qualitative data.

Yet another instrumentality of the invention monitors the storage criteria set by system administrators regarding the type and amount of log data that is to be stored by the license manager and, noting that storage criteria, develops its own independent criteria for separately storing the missing or non-stored information for later use. This instrumentality can, for example, set a specified period during which the extra information is maintained or stored in compacted or coded fashion, such that it is available if it should happen that the user has a need for that historical information and that information has not otherwise been logged by the XSLM license manager.

Thus, the invention is a data retrieving system for a computer, including a plurality of application programs that operate with license certificates. A software license manager handles issuance of license certificates to the plurality of applications programs and the data logger of the license manager creates log records containing data reflecting usage of application programs. The log records include parametric fields by which license certificate transactions are classified. A search formulating facility responds to user inputs by formulating parametric criteria in the form of log data searching specifications which are then used by a data collection facility to search through the log records to retrieve records that comply with the searching specification created by the data retrieving facility.

Other features and advantages of the present invention will become apparent from the following description of the invention which refers to the accompanying drawings.

### BRIEF DESCRIPTION OF THE DRAWINGS

FIG. 1 shows a free format data specification for an XSLM License Manager.

FIG. 2 diagrammatically illustrates search parameters based on class, type and subtype.

FIG. 3 is a software flow chart.

FIG. 4 is a modification of the software flow charts of FIG. 3.

FIG. 5 diagrammatically illustrates the setting of parameters for a search.

FIGS. 6 and 7 are flow charts of software procedures of the present invention.

### DETAILED DESCRIPTION OF EMBODIMENTS OF THE INVENTION

The term “intercept” means the ability to alter the flow of control of an existing program or operating system in a transparent manner in order to perform a prescribed operation and then return control back to the intercept point and continue processing as though nothing has happened as far as the existing program or operating system is concerned. Typically, techniques for introducing, or “hooking”, an additional set of instructions into an existing program or operating system are familiar to those skilled in the art. These may include techniques such as renaming an existing module and substituting a module with the original name or dynamically changing an address vector to point to the new program, retaining the address of the original program so it can be invoked after the new program completes its operations.

As used herein, the term “exit” represents a point in a software product at which a user exit routine may be given control to change or extend the functions of the software product at user-specified events. Exit routines are written to replace one or more existing modules of a software product, or are added to a software product as one or more modules or subroutines. While hooking is provided unbeknownst to the hooked application, exit routines are expected to be used and their interactions with the application is expected to follow certain rules defined by the application.

The present invention provides a method by which the request and retrieval of those log records within a specified time period corresponding to multiple combinations of class, type, and/or subtype are consolidated such that the overhead of performing a search through all the log records pertaining to the specified period for each such combination is not incurred.

The present invention further provides a method for determining the last occasion that a license was granted for a specified product by the XSLM without requiring log records searches over an arbitrary time period that may or may not contain the last occasion of use.

The present invention also provides a method by which an application program or utility may request and retrieve log data, as defined by their class, type, and/or subtype, even if one or more of those particular log records have been designated by the user to be filtered out, and therefore have not been written by the XSLM to the XSLM system log data file.

In a preferred embodiment, the present invention achieves the foregoing functions by extending the functional capabilities of the XSLM management API beyond those described in the approved XSLM standard produced by The Open Group. This set of extended management APIs is referred to as the EMAPI.

The method of extending the capabilities of the management APIs is accomplished in several ways:

EMAPI functions are incorporated into the XSLM by the XSLM vendor;

EMAPI functions are implemented by augmenting the XSLM using exit routines;

EMAPI functions are implemented by augmenting the XSLM using intercepts such as intercepting API calls to the XSLM server; and,

Combinations of the above.

Consolidated retrieval of log records of multiple class, type, and subtype: In this embodiment, the EMAPI function GETLOGX acts in accordance to user supplied class, type and subtype data to return the desired records from the XSLM log.

In one mode of operation, GETLOGX accepts parametric class, type and subtype information as input data. The current EMAPI function allows the issuer to request any number of classes, and for each class, any number of types, and for each type, any number of subtypes.

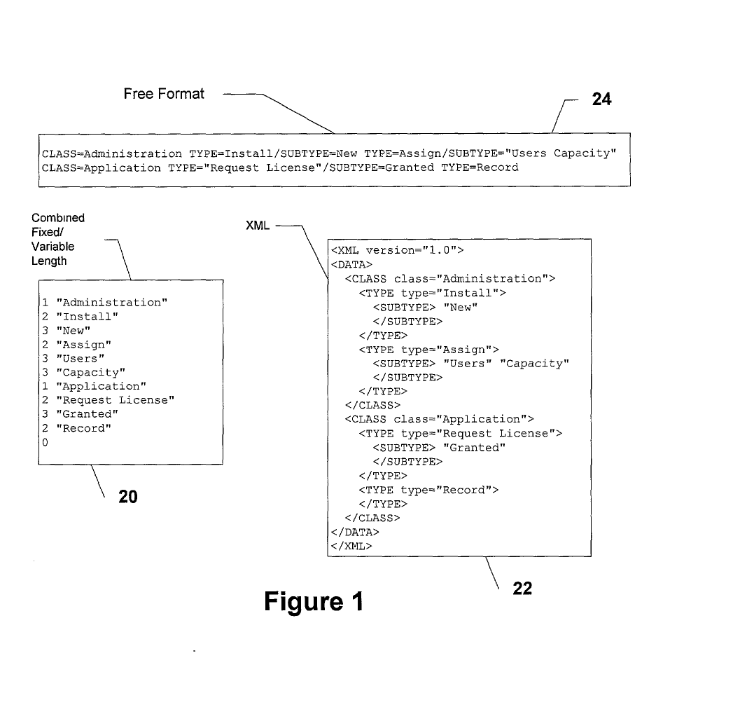

A feature of GETLOGX and other EMAPI functions is that input data can be provided in a variety of formats such as (see FIG. 1):

Combined fixed and variable length data records 20;

Variable length data records;

Extensible Markup Language (XML) 22;

Free format text strings 24;

Name or token for a pre-defined (“canned”) specification.

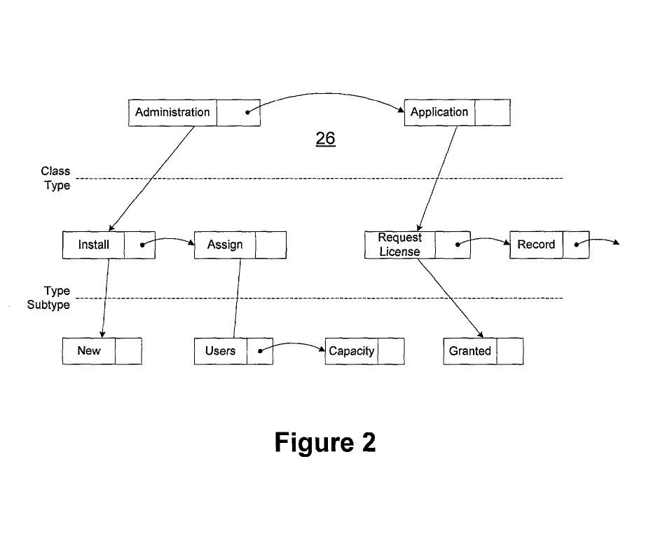

Upon receiving the input parameters, GETLOGX converts them, if necessary, into a form that is more amenable to searching for records that meet the input specification. For example, the parameters can be converted into a tree-list 26 such as shown in FIG. 2. Alternatively, as there is a limited number of combinations of class, type and subtype; a binary truth table (not shown) is also easily constructed.

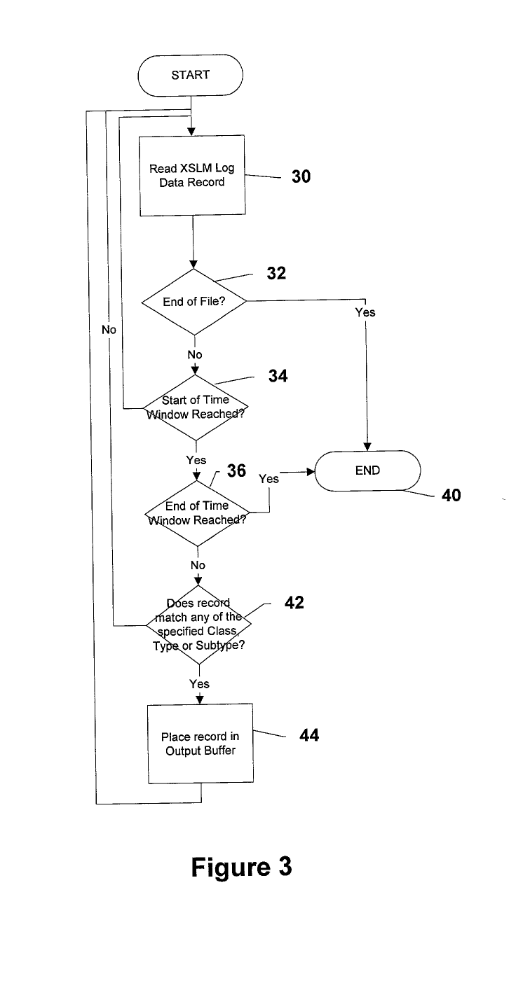

Referring to FIG. 3, the general method of operation is to first locate the start of the time window (steps 30-40), and then to continue scanning the XSLM log file for matching records (step 42). When a record is encountered that matches an entry in the tree-list or a request in a truth table, that record is placed in the output buffer (step 44) to be returned to the calling program. As additional records are located, they are added to the output buffer. The process continues until all records in the log file have been searched or the end of the time window is encountered (step 40).

Normally, the output buffer 44 used by GETLOGX is either provided by the calling program or an internal memory buffer, the contents of which are eventually returned to the calling program to process. Optionally, the calling program may specify that the contents of the output buffer be directed to a storage file for processing at a later time or by another process.

Additionally, GETLOGX accepts start and stop times (i.e., a time window) as input parameters to narrow the search for matching records of the specified class, type and subtypes. Optionally, the calling program may specify different time windows and/or sub-intervals to be applied to individual class, type and subtype specifications. For example, a specification may request matching records from Jan. 1, 2000 through Jun. 30, 2000 and that the sub-intervals be limited to the “weekdays” therein.

As an alternative, or in addition, to the above technique, the calling program may take advantage of the specification builder (SB) feature common to GETLOGX and other EMAPI functions. The purpose of the SB is to accept and accumulate a set of one or more search parameters and to construct a complete search specification from the input parameters received without acting upon them. The first time the SB is invoked, it establishes in its own memory a table or list to retain the specified class, type, and subtype specifications. As additional calls are made, the SB adds the new specifications to those already accumulated until such time that the calling program directs GETLOGX to actually process the request and perform a search.

The SB can be invoked directly by the calling program the same as any other EMAPI function or by calling an EMAPI function such as GETLOGX with an additional argument to either “defer” and accumulate the specification or to “process” the specification. Functionally, the operation proceeds as

GETLOGX (spec1, defer)

GETLOGX (spec2, defer)

GETLOGX (spec3, defer)

. . .

GETLOGX (specN, process)

where the final call directs the search to be performed.

Typically, the search specification is reset after it is processed. Optionally, the calling program can direct that the SB retain the specification, or return the complete specification to the calling program, or “undo” the last partial specification, or save the specification and assign it a token for future reference, etc.

Optionally, the SB accepts specifications in any of the formats previously described. For example, a first call might provide the data as free format text strings, a second call in XML format, etc.

For example, the following sequence of 11 function calls, each specifying a single class, type and subtype, requests the same set of class, type and subtype as though it were made with a single call to GETLOGX.

| | Class | Type | Subtype | Flag |
|---|---|---|---|---|
| 1 | Administration | Install | New | defer |
| 2 | Administration | Install | Replace | defer |
| 3 | Administration | Assign | Nodes | defer |
| 4 | Administration | Assign | Users | defer |
| 5 | Administration | Assign | Capacity | defer |
| 6 | Administration | Set_Policy | Confirm_Interval | defer |
| 7 | Administration | Set_Policy | Reset_Counters | defer |
| 8 | Administration | Set_Policy | Hard_Soft_Stop | defer |
| 9 | Application | Request_License | Granted | defer |
| 10 | Application | Record | Consumptive | defer |
| 11 | Application | Record | Cumulative | process |

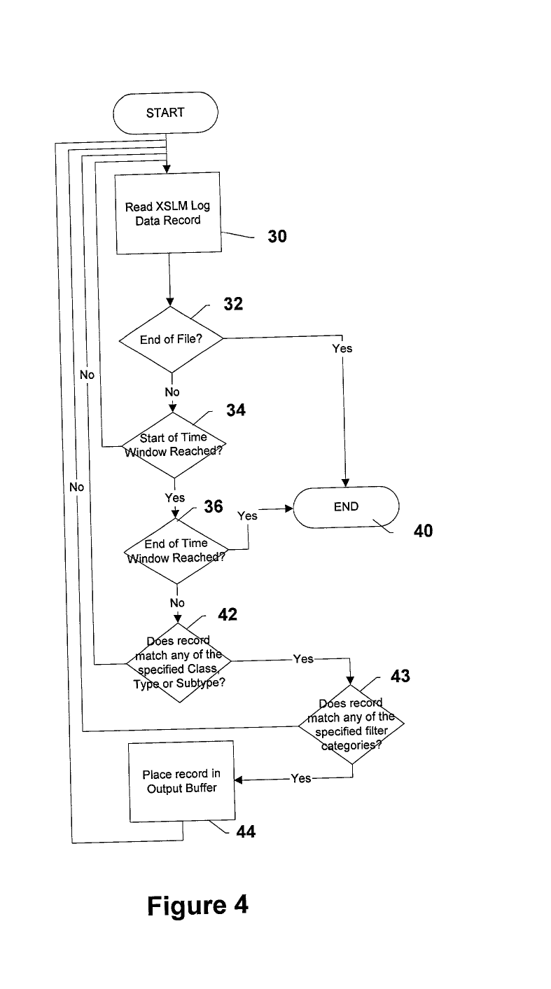

As a further optional enhancement to the above techniques, GETLOGX accepts additional input data allowing the specification of filters pertaining to categories such as vendors/products, users or computers. As shown in FIG. 4, the filtering operation (step 43) is applied as an extra step to the decision to return data to the calling program.

Within a filter category, a log record is considered to match that category if it matches at least one of the supplied filters. If multiple filter categories are supplied in the request, a log record must match each such category. In the case of the vendors/products category, log records must match at least one vendor/product combination.

The specification of filter categories is performed in the same manner as providing a search specification, i.e., a variety of input formats and the accumulation of filter elements by the SB. Optionally, the calling program can provide a buffer containing the desired filter elements in a form compatible with the GETLOGX EMAPI function.

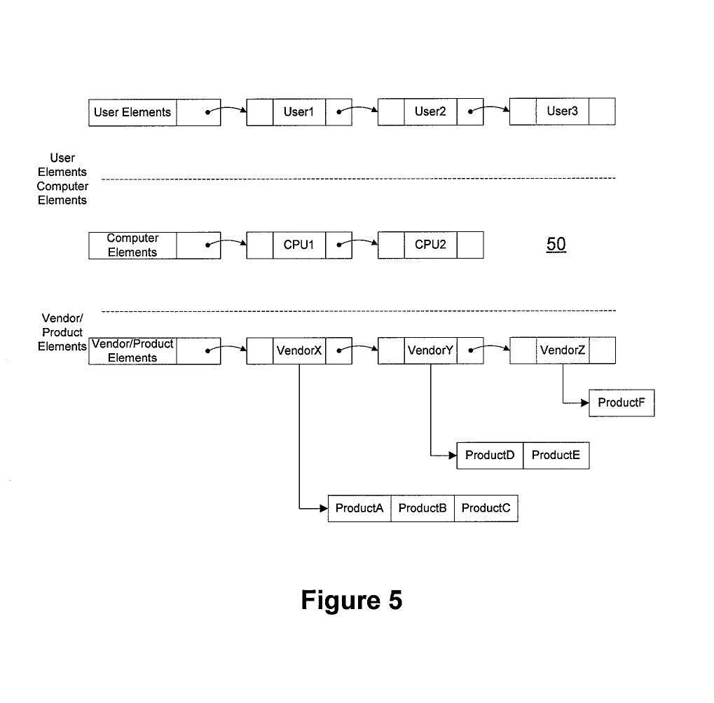

For example, a calling program may desire to restrict the log records returned by GETLOGX to those applicable to User1, User2 or User3, but only if the user was operating on CPU1 or CPU2, and only regarding ProductA, ProductB or ProductC, all from VendorX, or ProductD or ProductE, both from VendorY, or ProductF from VendorZ. Graphically, the filter element list 50 for these might appear as in FIG. 5.

The data contained within each filter category is typically textual, e.g., ASCII characters. Accordingly, the present invention permits the calling program to provide a “regular expression” for each category. A regular expression, such as is used by the Unix grep program, is a pattern of characters and operators that describes matching rules for a set of character strings. For example, the regular expression “[A-Z0-9]” indicates to return character strings that are uppercase only and may contain any number.

In another embodiment of the present invention, a method is provided for determining the last occasion that a license was granted for a specified product by the XSLM without requiring that log records be searched over an arbitrary time period.

If a determination must be made as to when a license for a particular product was last granted by the XSLM (in other words, when the product was last used), the overhead associated by retrieving all the log records (if they even exist) associated with xslm_get_certificate( ) requests is largely eliminated by use of an EMAPI function called GETLASTUSE.

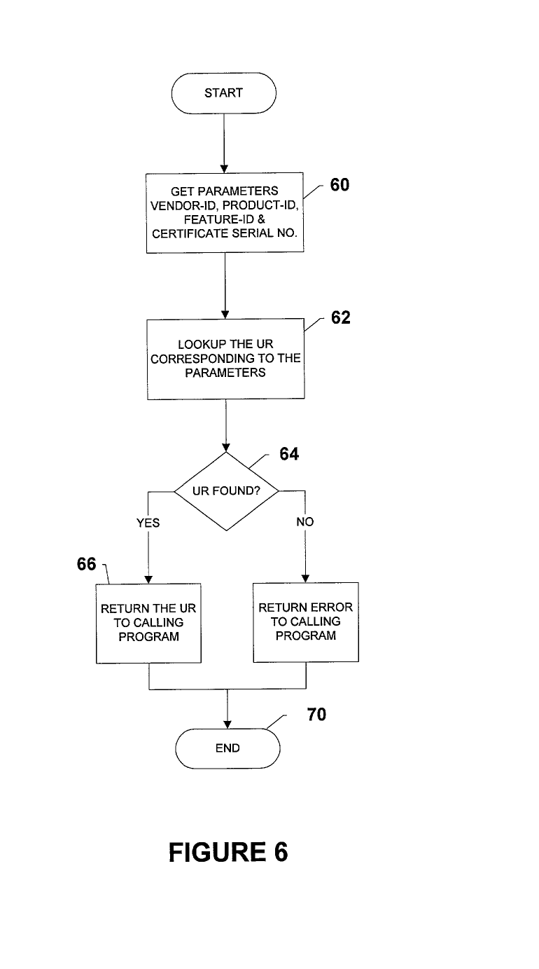

The calling program provides GETLASTUSE with input parameters such as the vendor-id, product-id, version-id, feature-id and certificate serial number for which the last use is requested (step 60, FIG. 6). As listed, these parameters are ordered by increasing specificity, with the most general one (vendor-id) first. One, some, or all of the parameters may be supplied, but only if, for each supplied parameter, all more general parameters are also supplied. A parameter value of “any” is permitted. Parameters not supplied are assumed to mean “any”.

In support of this function, the XSLM server is modified to maintain a Usage Record (UR) that is correlated to each certificate known to the XSLM system. Each UR contains the time and date of the last successful xslm_get_certificate( ) request associated with the product covered by the certificate. The URs may reside in memory or in a database.

Thereafter, (FIG. 6) when an application issues a GETLASTUSE request, the XSLM examines each UR (step 62) to determine if the associated vendor name, product name, etc. satisfies the request. If so, the time and date of last use are extracted from the UR and returned to the application, along with the data from any other URs that match the request (step 66, 70). Thus, the calling program may request information about a single product, or all products from a particular vendor, etc.

The XSLM specification allows for several certificates to be grouped together within one encompassing certificate. Each such “inner” certificate is treated as a unique certificate, and the XSLM system maintains a UR for each one of them, as well as for the “outer” certificate.

The XSLM specification also allows multiple certificates to cover the same combination of publisher, product, feature, and version. In such cases, the XSLM may grant a license from any one of these certificates, assuming that it otherwise would be used to grant a license. The XSLM system maintains a separate UR for each such certificate.

Optionally, GETLASTUSE additionally accepts an input parameter specifying a particular computer-id. If supplied, the time of last use of the product on the specified computer is returned to the requesting application. In support of this capability, as XSLM processes xslm_get_certificate( ) requests, the XSLM searches for a UR matching the computer-id, certificate, vendor, product, version, etc. specified in the request. If no matching UR is found, one is dynamically created. The UR is then updated with the date and time of last use. Thereafter, when an application issues a GETLASTUSE request, the XSLM examines each UR to determine if the associated computer-id, vendor name, product name, etc. satisfies the request. If so, the time and date of last use are extracted from the UR and returned to the application.

In another embodiment of the present invention, a method is provided by which an application program or utility is ensured that certain types of log records are available for retrieval even if one or more of those particular log records have been designated by the user to be filtered out, and therefore are not written by the XSLM to the XSLM system log data file.

The SET_RECORDING_STATUS EMAPI function permits an application to specify that the data that would normally be contained in certain log records be written to a recording file. The resulting data records in the recording file (RFRs) contain the same information as their corresponding XSLM log records, though the format may differ, and (if so specified) are written to the recording file whether or not the corresponding log record is written to the XSLM log file. (Note that the recording file and log file are logical entities, and both may be stored in the same physical file or database.)

SET_RECORDING_STATUS accepts an input parameter that specifies (selects) which log records are to have RFRs created therefor. Similarly, SET_RECORDING_STATUS also accepts an input parameter that specifies which log records are to be suppressed, i.e., not to have an RFR created even if they were previously included in a prior select specification. The specification of selected/suppressed log records is according to their class, type, and subtype triplets (i.e., groups). In other words, applicable log records would have to match the grouping of class and type and subtype that has been specified.

SET_RECORDING_STATUS also accepts a set of input parameters that specify the scope of the select/suppress specification. These scope-defining parameters include items such as the XSLM vendor-id, product-id, version-id, feature-id, and certificate-serial-number. As listed, these parameters are ordered by increasing specificity, with the most general one (vendor-id) first. One should note that this order is in accordance to their definition in the XSLM specification.

One, some, or all of the parameters may be supplied, but only if, for each supplied parameter, all of the more general parameters are also supplied. For example, a product-id has no meaning except when associated with a vendor-id; a version-id is associated to a particular product-id; etc.

Only those log records pertaining to entities falling within the scope are subject to the specifications of the select/suppress parameters.

A parameter value of “any” is accepted by SET_RECORDING_STATUS. Values not supplied are also assumed to mean “any”.

For example, if an application wishes to ensure that RFRs are created from log record data derived from two distinct groups of log records such as new software installations and granting of licenses:

1 Administration, Install, and New (AIN); and

2 Application, Request_license, and Granted (ARG).

The parameters provided to SET_RECORDING_STATUS would comprise “select” in combination with AIN and ARG.

Extending this example, the application can refine the selection process to pertain to only three vendors (IBM, BMC and CA); three IBM products (IMS version 4, all versions of DB2, and version 7 of TSO with the exception of the TBT feature); all products from BMC except PATROL; two CA products (all versions of JARS except version 2, and version 5 of ACF2 but restricted to the ABC feature and only if covered by certificate #345). The desired effect is achieved via the following sequence of requests to SET_RECORDING_STATUS:

| Group | Vendor-id | Prod-id | Vers-id | Feature-id | Cert# | |
|---|---|---|---|---|---|---|
| 1 Select | ARG,AIN | IBM | IMS | 4 | None | Any |
| 2 Select | ARG,AIN | IBM | DB2 | Any | Any | Any |
| 3 Select | ARG,AIN | IBM | TSO | 7 | None | Any |
| 4 Suppress | ARG,AIN | IBM | TSO | 7 | TBT | Any |
| 5 Select | ARG,AIN | BMC | Any | Any | Any | Any |
| 6 Suppress | ARG,AIN | BMC | PATROL | Any | Any | Any |
| 7 Select | ARG,AIN | CA | JARS | Any | Any | Any |
| 8 Suppress | ARG,AIN | CA | JARS | 2 | None | Any |
| 9 Select | ARG,AIN | CA | ACF2 | 5 | ABC | 345 |

In order to make the data contained in RFR records available to the application, GETLOGX is further extended so that in addition to searching through all logged records to find those matching the GETLOGX request, the set of RFR records is searched as well. Data is returned to the calling program in the same format, whether it came from an XSLM log record or an RFR record. If data exists in both a log record and an RFR record corresponding to the same event, only a single set of data is returned. Thus, RFR data is available to applications using the GETLOGX function, but only to them, while the volume of data placed on the actual XSLM log, and which must be processed by other routine administrative functions, is minimized.

As described above, all RFR records are written to a single logical RFR file. Thus, all applications wishing to use RFRs as described above, and obtain the described benefits, will have their RFRs lumped together in a common logical file which is accessed whenever any application retrieves RFR data.

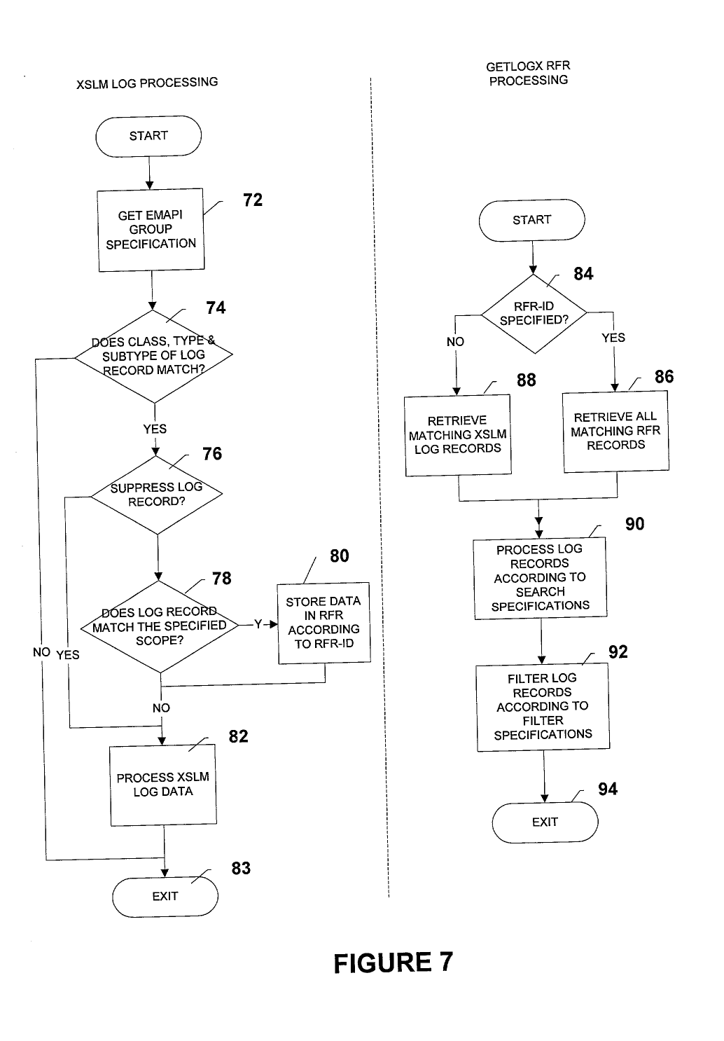

In an enhancement of the current embodiment, calling applications may further reduce the overhead associated with their processing of log data. In this further extension of the EMAPI, both GETLOGX and SET_RECORDING_STATUS accept a parameter specifying an RFR-id parameter. Referring to FIG. 7, for each unique RFR-id supplied in one or more SET_RECORDING_STATUS calls, the XSLM system records all RFRs in a distinct logical RFR file correlated with that RFR-id. RFRs contained on a particular logical RFR file are then supplied only to those GETLOGX calls that supply a matching RFR-id. In this way, RFR data created by a particular application, using a particular RFR-id, is isolated from RFR data created by those applications using other RFR-ids, resulting in reduced processing overhead.

More specifically, and with reference to FIG. 7, the operation of XSLM log processing is set forth at steps 72-83 on the left-hand side of FIG. 7, whereas various steps associated with the GETLOGX RFR processing is set forth as steps 84-94 on the right-hand side of FIG. 7, in a self-explanatory manner.

The correlation of log data to RFR-ids can be performed in a manner such as an index into a data base file, creating and writing data to a separate file for each RFR-id, etc.

Optionally, the calling application may have SET_RECORDING_STATUS assign a unique value to the RFR-id, returning it to the application, when a value of zero is provided.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

We claim:

1. A data retrieving system for a computer including a plurality of application programs operable with respective license certificates, the system comprising:
a software license manager for handling issuance of license certificates to the plurality of application programs;
a data logger associated with the license manager, the data logger creates log records containing data reflecting usage of application programs, the log records including parametric fields by which license certificate transactions are classified;
a search formulating facility responsive to user inputs, formulates parametric criteria in the form of log data searching specifications; and
a data collection facility responsive to the data retrieving facility searches through the log records to retrieve records that comply with the searching specifications created by the data retrieving facility.

2. The system of claim 1, in which the search formulating facility and the data collection facility are integrated within the license manager.

3. The system of claim 1, in which the search formulating facility and the data collection facility are coupled to the license manager by exit routines.

4. The system of claim 1, in which functionalities provided by the search formulating facility and the data collection facility are implemented by augmenting the license manager using intercepts.

5. The system of claim 1, in which the parametric criteria comprises one or more of:
combined, fixed and variable length data records; variable length data records; extensible markup language (XML); free format text strings; and name or token for pre-defined specification.

6. The system of claim 1, in which the parametric criteria are converted into a tree-list format.

7. The system of claim 1, in which the parametric criteria are converted into a binary truth table.

8. The system of claim 1, in which the data collection facility temporarily maintains data retrieved from among the log records in an output buffer.

9. The system of claim 1, in which the parametric criteria includes start and stop times.

10. The system of claim 1, further comprising a specification builder for building parametric criteria for a user.

11. The system of claim 10, including a selection of a plurality of pre-defined search parameters.

12. The system of claim 1, further comprising filter categories and the data collection facility being responsive to the filter categories.

13. The system of claim 12, in which the filter categories enable the searching for data by reference to user-id in combination with CPU-id.

14. The system of claim 12, in which filter categories specification are maintained in textual format.

15. The system of claim 1, further comprising a get-last-use facility that determines the last occasion that a license was granted for a specified product without requiring that log records be searched over an arbitrary time period.

16. The system of claim 15, in which the get-last-use facility operates with input parameters ordered by increasing specificity.

17. The system of claim 16, in which the get-last-use facility operates in conjunction with usage records that are correlated to respective certificates, with corresponding usage records containing the time and date of a last successful certificate request.

18. The system of claim 1, further comprising an auxiliary data logger that stores in a recording file data records that have been designated by the user to be filtered out.

19. The system of claim 18, in which the auxiliary data logger is capable of receiving an input parameter that specifies log records that are not to be stored in the recording file.

20. The system of claim 19, in which the data logger further accepts a set of input parameters that specify the scope of license use records to be stored as log records.

21. The system of claim 20, in which the data collection facility searches both through the log records and the data records stored in the recording file.

22. The system of claim 18, in which all data records associated with the recording file are written to a single logical file.

23. The system of claim 18, in which the application programs specify recording file-id parameters such that data records in the recording file contained in a particular logical recording file are supplied only to those application programs that supply a correct matching id.
